(19) United States
(12) Patent Application Publication
(10) Pub. No.: US 2025/0013780 A1
(43) Pub. Date: Jan. 9, 2025

(54) System and method for improving security in a computing environment

(71) Applicant: Bank of America Corporation, Charlotte, NC (US)

(72) Inventors: George Albero, Charlotte, NC (US); Maharaj Mukherjee, Poughkeepsie, NY (US)

(21) Appl. No.: 18/348,511

(22) Filed: Jul. 7, 2023

(51) Int. Cl. G06F 21/62; H04L 51/063; H04L 51/212

(52) U.S. Cl. CPC G06F 21/6245; H04L 51/063; H04L 51/212

(57) ABSTRACT

A system includes a memory and a processor configured to monitor a plurality of written electronic communications from as first user and a second user, wherein the first user has access to confidential information and the second user does not have access to the confidential information. Based on the monitoring, the processor determines a text pattern common across at least a portion of the communications. The processor compares the text pattern with the confidential information and determines a first correlation pattern between the text pattern and the confidential information. In response to determining the first correlation pattern, the processor determines that the first user included confidential information in the communications, raises an alert, and blocks subsequent communications between the first user and the second user.

### TECHNICAL FELD

The present disclosure relates generally to network security, and more specifically to a system and method for improving security in a computing environment.

### BACKGROUND

A computing infrastructure (e.g., IT infrastructure of an organization) may be configured to store confidential information, for example, in one or more computing nodes or databases of the computing infrastructure. Confidential information may include data relating to an organization that has not been made public and can impact a value of assets associated with the organization. For example, the confidential information may include, but is not limited to, material nonpublic information such as performance related data of the organization, information relating to internal operations of the organization, information relating to associations or planned associations and/or partnerships of the organization with other partner organizations that has not been made public, and information related to legal proceeding and/or regulatory procedures initiated against the organization that has not been made public. Generally, interactions including obtaining and/or relinquishing assets associated with the organization based on knowledge of information associated with the organization that has not been made public is against the law in most countries as such interactions may unfairly benefit certain individuals and/or entities involved in the interactions. Stolen or otherwise leaked confidential information relating to an organization may cause significant harm to the organization including legal/regulatory repercussions, loss of reputation, and loss of revenue.

### SUMMARY

The system and method implemented by the system as disclosed in the present disclosure provide technical solutions to the technical problems discussed above by providing enhanced data security in a computing infrastructure.

For example, the disclosed system and methods provide the practical application of detecting as well as avoiding leakage and theft of confidential information stored in a computing infrastructure. As described in embodiments of the present disclosure, a security manager monitors a plurality of electronic communications sent from a private user who has access to the confidential information to a public user who does not have access to the confidential information. Based on the monitoring, security manager determines a particular text pattern repeatedly used in the communications. Security manager correlates the identified text pattern to the confidential information or portions thereof the private user has access to and determines a first correlation pattern between the text pattern and the confidential information. Additionally or alternatively, the security manager may determine a second correlation pattern between the text pattern identified in the communications and certain controlled interactions performed by the public user. Further, security manager may determine a third correlation pattern between the first and the second correlation patterns. Security manager may determine that the private user included confidential information in one or more communications sent to the public user based on determining one or more of the first correlation pattern, the second correlation pattern and the third correlation pattern.

By intelligently detecting when a private user sends confidential information to a public user, the disclosed system and method improve overall data security and network security of the computing infrastructure. Additionally, by proactively monitoring communications between a private user and public user and detecting leakage of confidential data, the disclosed system and method save processing and memory resources that would other be used after the confidential information is stolen to trace the source of leakage. Thus, by saving processing and memory resources, the disclosed system and method improve performance of computing nodes employed in the computing infrastructure.

Thus, the disclosed system and method generally improve the technology associated with data and network security.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure; and

FIG. 2 illustrates a flowchart of an example method for securing confidential information, in accordance with one or more embodiments of the present disclosure.

### DETAILED DESCRIPTION

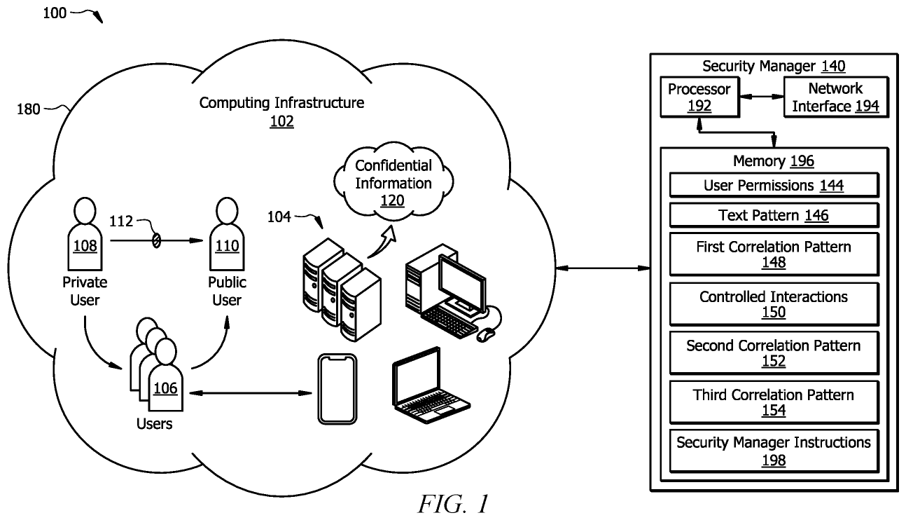

FIG. 1 is a schematic diagram of a system 100, in accordance with certain aspects of the present disclosure. As shown, system 100 includes a computing infrastructure 102 including a plurality of computing nodes 104 connected to a network 180. Computing infrastructure 102 may include a plurality of hardware and software components. The hardware components may include, but are not limited to, computing nodes 104 such as desktop computers, smartphones, tablet computers, laptop computers, servers and data centers, virtual reality (VR) headsets, augmented reality (AR) glasses and other hardware devices such as printers, routers, hubs, switches, and memory devices all connected to the network 180. Software components may include software applications that are run by one or more of the computing nodes 104 including, but not limited to, operating systems, user interface applications, web applications, third party software, database management software, service management software, metaverse software and other customized software programs implementing particular functionalities. For example, software code relating to one or more software applications may be stored in a memory device and one or more processors may process the software code to implement respective functionalities.

One or more of the computing nodes 104 may be operated by a user 106. For example, a computing node 104 may provide a user interface using which a user 106 may operate the computing node 104 to perform data interactions within the computing infrastructure 102. For example, a user 106 may use a laptop computer to access a web application running on a server, wherein both the laptop computer and the server are part of the computing infrastructure 102. As described further below, at least a first portion of the users 106 may be designated as private users 108 and at least a second portion of the users 108 may be designated as public users.

In one embodiment, at least a first portion of the computing infrastructure 102 may be representative of an Information Technology (IT) infrastructure of an organization.

One or more computing nodes 104 of the computing infrastructure 102 may be representative of a computing system that hosts software applications which may be installed and run locally or may be used to access software applications running on a server (not shown). The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server running one or more software applications to implement respective functionality (e.g., security manager 140) as described below. In certain embodiments, one or more of the computing nodes 104 may run a thin client software application where the processing is directed by the thin client but largely performed by a central entity such as a server (not shown).

Network 180, in general, may be a wide area network (WAN), a personal area network (PAN), a cellular network, or any other technology that allows devices to communicate electronically with other devices. In one or more embodiments, network 180 may be the Internet.

The security manager 140 comprises a processor 192, a memory 196, and a network interface 194. The security manager 140 may be configured as shown in FIG. 1 or in any other suitable configuration.

The processor 192 comprises one or more processors operably coupled to the memory 196. The processor 192 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 192 may be a programmable logic device, a microcontroller, a microprocessor, or any suitable combination of the preceding. The processor 192 is communicatively coupled to and in signal communication with the memory 196. The one or more processors are configured to process data and may be implemented in hardware or software. For example, the processor 192 may be 8-bit, 16-bit, 32-bit, 64-bit or of any other suitable architecture. The processor 192 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

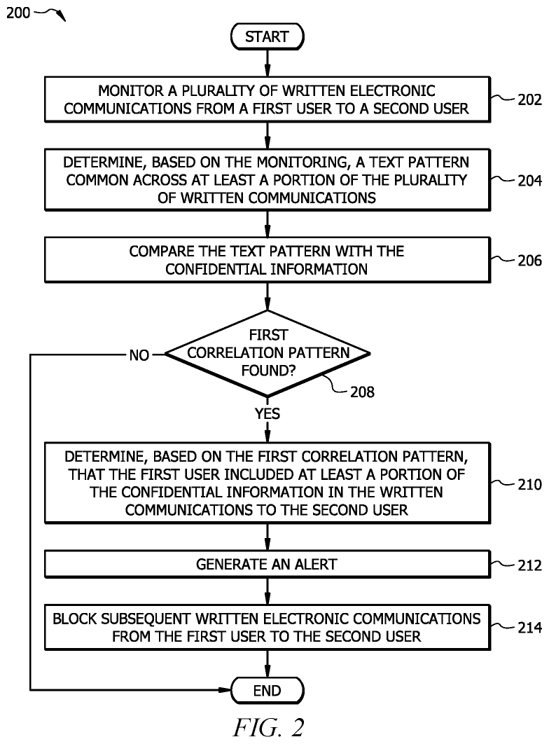

The one or more processors are configured to implement various instructions, such as software instructions. For example, the one or more processors are configured to execute instructions (e.g., security manager instructions 198) to implement the security manager 140. In this way, processor 192 may be a special-purpose computer designed to implement the functions disclosed herein. In one or more embodiments, the security manager 140 is implemented using logic units, FPGAs, ASICs, DSPs, or any other suitable hardware. The security manager 140 is configured to operate as described with reference to FIG. 2. For example, the processor 192 may be configured to perform at least a portion of the method 200 as described in FIG. 2.

The memory 196 comprises a non-transitory computer-readable medium such as one or more disks, tape drives, or solid-state drives, and may be used as an over-flow data storage device, to store programs when such programs are selected for execution, and to store instructions and data that are read during program execution. The memory 196 may be volatile or non-volatile and may comprise a read-only memory (ROM), random-access memory (RAM), ternary content-addressable memory (TCAM), dynamic random-access memory (DRAM), and static random-access memory (SRAM).

The memory 196 is operable to store user permissions 144, text pattern 146, first correlation pattern 148, controlled interactions 150, second correlation pattern 152, third correlation pattern 154, and the security manager instructions 198. The security manager instructions 198 may include any suitable set of instructions, logic, rules, or code operable to execute the security manager 140.

The network interface 194 is configured to enable wired and/or wireless communications. The network interface 194 is configured to communicate data between the security manager 140 and other devices, systems, or domains (e.g., computing nodes 104 etc.). For example, the network interface 194 may comprise a Wi-Fi interface, a LAN interface, a WAN interface, a modem, a switch, or a router. The processor 192 is configured to send and receive data using the network interface 194. The network interface 194 may be configured to use any suitable type of communication protocol as would be appreciated by one of ordinary skill in the art.

It may be noted that each of the computing nodes 104 may be implemented like the security manager 140 shown in FIG. 1. For example, each of the computing nodes 104 may have a respective processor and a memory that stores data and instructions to perform operations discussed above.

Computing infrastructure 102 (e.g., IT infrastructure of an organization) may be configured to store confidential information 120, for example, in one or more computing nodes 104 or databases of the computing infrastructure 102. Confidential information 120 may include data relating to an organization that has not been made public and can impact a value of assets associated with the organization. For example, the confidential information 120 may include, but is not limited to, material nonpublic information such as performance related data of the organization, information relating to internal operations of the organization, information relating to associations or planned associations and/or partnerships of the organization with other partner organizations that has not been made public, and information related to legal proceeding and/or regulatory procedures initiated against the organization that has not been made public. Generally, interactions including obtaining and/or relinquishing assets associated with the organization based on knowledge of information associated with the organization that has not been made public is against the law in most countries as such interactions may unfairly benefit certain individuals and/or entities involved in the interactions. Stolen or otherwise leaked confidential information relating to an organization may cause significant harm to the organization including legal/regulatory repercussions, loss of reputation, and loss of revenue.

Embodiments of the present disclosure describe techniques to detect as well as avoid leakage and theft of confidential information 120 stored in a computing infrastructure 102.

Often an organization places different levels of permissions and controls for different users 106 with regard to access of confidential information 120 stored in the organization's IT infrastructure (e.g., computing infrastructure 102 or a portion thereof). For example, a first portion of the users 106 may be designated as private users 108 who have access to the confidential information 120. For example, private users 108 may be responsible to generate and/or maintain the confidential information 120 within the computing infrastructure 102. On the other hand, a second portion of the users 106 may be designated as public users 108 who do not have access to the confidential information 120. Additionally, private users 108 who have access to confidential information 120 generally are subject to higher level of monitoring and control to detect any potential theft or leakage of the confidential information 120 to persons or entities outside the organization. For example, private users 108 may not be allowed to send out electronic communications to persons outside the organization. Further, strict controls may be placed on private users 108 in relation to performing certain interactions (e.g., controlled interactions 150) associated with obtaining or relinquishing assets associated with the organization to which the confidential information 120 relates. However, since public users 110 do not have access to the confidential information 120, they are generally subject to lower levels of monitoring and control compared to private users 108. For example, public users 110 may be allowed to send out electronic communications to persons outside the organization and may freely or with little scrutiny perform interactions (e.g., controlled interactions 150) associated with obtaining or relinquishing assets associated with the organization to which the confidential information 120 relates.

Typically, organizations allow private users 108 to send electronic communications (e.g., electronica written communications such as emails, internal chat messages etc.) to public users 110 within the organization as these communications are considered internal communications. In some cases, a private user 108 of the organization may misuse this right to send confidential information to a public user 110 of the organization who may obtain or relinquish assets associated with an entity (e.g., the organization or other partner organizations) based on the confidential information received from the private user. This may be in accordance with a mutually beneficial relationship between the private user 108 and the public user 110. Since internal communications between users 106 (e.g., employees) of an organization are often monitored, a private user 108 may include confidential information in communications using pre-agreed code language that is non-standard code and thus is not readily recognizable or decodable using standard code breaking methods. Typically, the pre-agreed code used in such communications is crude but effective. For example, the pre-agreed code may use random words, phrases or sentences corresponding to communicate portions of the confidential information 120 or actions associated with the confidential information 120. For example, the pre-agreed code may use the word “ice cream” to refer to a particular name of an entity and may use the sentence “let's get some ice cream” to mean “obtain assets associated with the particular entity”. In this example, when the public user 110 receives an email communication from the private user 108 including the sentence “let's get some ice cream”, the public user 110 may proceed to obtain assets associated with the particular entity. Thus, innocuous looking communications between the private user 108 and the public user 110 may include confidential information 120 hidden in code. Presently, no method exists to recognize such coded language in written communications.

Security manager 140 may be configured to identify and decode coded language in written communications between a private user 108 and a public user 110, allowing for timely detection of confidential information 120 being communicated to a public user 110.

Security manager 140 may be configured store or otherwise have access to user permissions 144 that indicate whether a particular user 106 has access to confidential information 120. Additionally or alternative, user permissions 144 indicate whether a particular user 106 is authorized to perform certain controlled interactions 150. In an embodiment, a private user 108 has access to confidential information 120 and is not authorized to perform controlled interactions 150. On the other hand, a public user 110 does not have access to confidential information 120 and is authorized to perform controlled interactions 150. In the context of the present disclosure the term “controlled interactions 150” refers to certain interactions associated with obtaining or relinquishing assets associated with an organization/entity to which the confidential information 120 relates. Security manager 140 may be configured to determine whether a particular user 106 is a private user 108 or public user 110 based on the user permissions 144.

Security manager 140 may be configured to monitor electronic communications 112 between a private user 108 and a public user 110. The electronic communications 112 may include electronic written communications including, but not limited to, an electronic mail (email), a text message, and a written message sent on an internal chatting platform. It may be noted that the terms “electronic communication 112”, “electronic written communication 112” and “communication 112” are used interchangeably throughout this disclosure. Further, it may be noted that while embodiments of the present disclosure are described with reference to electronic written communications, a person having ordinary skill in the art may appreciate that the embodiments also apply to voice communications. Security manager 140 may be configured to monitor a plurality of electronic communications 112 from a private user 108 to the public user 110. Based on monitoring, the plurality of electronic communications 112, security manager 140 may be configured to determine a text pattern 146 that is common across at least a portion of the monitored electronic communications 112. For example, based on monitoring ten email communications that the private user 108 sent to the public user 110, security manager 140 may determine that a particular text pattern 146 is repeatedly used in six of the monitored email communications. Text pattern 146 may include, but is not limited to, repeated usage of one or more keywords, synonyms of the keywords, antonyms of the keywords or combinations thereof across the portion of the electronic communications 112; repeated usage of one or more phrases across the portion of the communications 112; repeated usage of a particular sentence structure across the portion of the written communications; and text from each of the portion of the written communications related to the same topic. One example text pattern 146 may include the sentence “let's get some ice cream” repeated across a threshold number of communications 112. Another example text pattern 146 may include the sentence “Red Sox are winning the baseball match” repeated across a threshold number of communications 112. In one embodiment, security manager 140 may be configured to designate a particular text pattern 146 as an identified text pattern 146 only when the text pattern 146 is found in at least a threshold number of monitored communications 112.

Once a particular text pattern 146 has been identified in communications 112 sent from the private user 108 to the public user 110, security manager 140 may be configured to determine a first correlation pattern 148 between the identified text pattern 146 and the confidential information 120 or portions thereof which the private user 108 has access to. As described above, security manager 140 may be configured to determine what confidential information 120 the private user 108 has access to by examining user permissions 144 associated with the private user 108. The first correlation pattern 148 indicates a pattern of correlation between the text pattern 146 and at least a portion of the confidential information 120. For example, the first correlation pattern 148 may include, but is not limited to, a correlation between one or more names in the confidential information 120 to an identified text pattern 146, a correlation between confidential information 120 related to performance data associated with an entity to the text pattern 146, a correlation between confidential information 120 related to a particular interaction associated with an entity to the text pattern; and a correlation between confidential information 120 related to internal operations of an entity to the text pattern. For example, an identified text pattern 146 may include the sentence “let's get some ice cream” repeated in several communication 112 from the private user 108 to the public user 110. By comparing, this identified text pattern to the confidential information 120 the private user 108 has access to, security manager 140 may determine a first correlation pattern 148 which may include the word “ice cream” correlated to a name of a particular entity, and the sentence “let's get some ice cream” correlated to “obtaining assets associated with the particular entity”. In another example, the identified text pattern may include the sentence “Red Sox are winning the baseball match”. In this example, the first correlation pattern 148 may include, the term “Red Sox” correlated to the name of a particular entity, “baseball match” correlated to performance of the particular entity, and the term “winning” correlated to improved performance of the particular entity.

In one or more embodiments, security manager 140 may be configured to identify the first correlation pattern 148 between an identified text pattern 146 and confidential information 120 by comparing a time at which a piece of confidential information 120 was made available to the private user 108 and a time at which the private user 108 sent a communication 112 to the public user 110. The idea here is that when the private user 108 repeatedly sends out a communication 112 to the public user 110 within a pre-set time period of a piece of confidential information 120 made available to the private user 108, there is a high likelihood that the private user 108 has included information associated with the piece of confidential information 120 in the communication 112. Security manager 140 may be configured to monitor when a piece of confidential information 120 is made available to the private user 108. For example, security manager 140 may record a time at which the private user 108 receives an email containing confidential performance related data associated with a particular entity. Security manager 140 may examine the performance related data received by the private user 108 and may determine that the performance related data indicates that the particular entity has had improved performance in the last 3 months. Upon detecting that the private user 108 sent a communication 112 to the public user 110 within a pre-set time period of receiving the performance related data, security manager 140 may be configured to compare a previously identified text pattern 146 with the performance related data and determine the first correlation pattern 146 between the text pattern 146 and the performance related data. In the example, when the identified text pattern 146 includes the sentence “Red Sox are winning the baseball match”, security manager 140 may determine the first correlation pattern 148 as including the term “Red Sox” correlated to the name of a particular entity, “baseball match” correlated to performance of the particular entity, and the term “winning” correlated to improved performance of the particular entity. In one embodiment, security manager 140 may be configured to designate a correlation pattern identified between the identified text pattern 146 and the piece of confidential information 120 as a valid and/or actionable first correlation pattern 148 only upon detecting the same correlation pattern in at least a threshold number of instances of the private user 108 receiving the piece of confidential information 120 and sending out a communication 112 to the public user 110 within the pre-set time period. In one embodiment, in response to determining the first correlation pattern 148, security manager 140 may be configured determine that the private user 108 included confidential information 120 in one or more communications 112 to the public user 110.

In one or more embodiments, security manager 140 may be configured to monitor one or more controlled interactions 150 performed by the public user 110. As described above, the term “controlled interactions 150” refers to certain interactions including and/or associated with obtaining or relinquishing assets associated with an organization/entity to which the confidential information 120 relates. Security manager 140 may be configured to determine a second correlation pattern 152 between controlled interactions 150 performed by the public user 110 and communications 112 received from the private user 108. For example, the second correlation pattern 152 may include a pattern of correlation between controlled interactions 150 performed by the public user 110 and an identified text pattern 146 in communications 112 received from the private user 108. In one embodiment, the second correlation pattern 152 may include a pattern of correlation between a particular type of controlled interactions 150 performed by the public user 110 and an identified text pattern 146 in communications 112 received from the private user 108. Security manager 140 may be configured to determine the second correlation pattern 152 based on comparing a time at which the public user 110 receives a communication 112 from the private user 108 and the time at which the public user 110 performs a controlled interaction 150. The idea here is that when the public user 110 repeatedly performs controlled interactions 150 within a pre-set time period of receiving communications 112 from the private user 108, there is a high likelihood that the public user 110 has received confidential information 120 in the communications 112 and is basing the controlled interactions 150 on the confidential information 120 received in the communications 112.

Upon detecting that the public user 110 performed a controlled interaction 150 within the pre-set time period of receiving a communication 112 from the private user 108, security manager 140 may be configured to compare a pre-identified text pattern 146 in the communication 112 with the controlled interaction 150 performed by the public user 110 and determine the second correlation pattern 152 based on the comparison. In the example, when the identified text pattern 146 in the communication 112 received by the public user 110 includes the sentence “Red Sox are winning the baseball match”, security manager 140 may detect a controlled interaction 150 performed by the public user 110 including obtaining one or more assets associated with a particular entity within the pre-set time period from receiving the communication 112. In this example, by comparing text pattern 146 and the controlled interaction 150, security manager 140 may determine the second correlation pattern as including the term “Red Sox” correlated to the name of the particular entity whose assets were obtained as part of the detected controlled interaction 150, “baseball match” correlated to performance of the particular entity, and the term “winning” correlated to improved performance of the particular entity. In one embodiment, security manager 140 may be configured to designate the correlation pattern identified between the identified text pattern 146 and a particular type of controlled interactions 150 (e.g., obtaining assets of the particular entity) as a valid and/or actionable first correlation pattern 148 only upon detecting the same correlation pattern in at least a threshold number of instances of the public user 110 receiving communications 112 from the private user 108 and the public user 110 performing the particular type of controlled interactions 150 with the pre-set time period of receiving the communications 112. In one embodiment, in response to determining the second correlation pattern 152, security manager 140 may be configured determine that the private user 108 included confidential information 120 in one or more communications 112 to the public user 110.

In one or more embodiments, security manager 140 may be configured to determine a third correlation pattern 154 between the first correlation pattern 148 and the second correlation pattern 152. In one embodiment, the determination of the third correlation pattern 154 may act as a confirmation that the private user 108 included a particular piece of confidential information 120 in communications 112 to the public user 110. The third correlation pattern 154 may include a correlation between the first correlation pattern 148 between the confidential information 120 and an identified text pattern 146, and the second correlation pattern between controlled interactions 150 performed by the public user 110 and the same identified text pattern 146 included in communications 112 received from the private user 108. Following the example described above wherein the identified text pattern 146 includes the sentence “Red Sox are winning the baseball match”, the first correlation pattern 148 may be determined as including the term “Red Sox” correlated to the name of a particular entity, “baseball match” correlated to performance of the particular entity, and the term “winning” correlated to improved performance of the particular entity. Additionally, the second correlation pattern 152 may also be determined as including the term “Red Sox” correlated to the name of the particular entity whose assets were obtained as part of the detected controlled interaction 150, “baseball match” correlated to performance of the particular entity, and the term “winning” correlated to improved performance of the particular entity. In this example, upon comparing the first correlation pattern 148 with the second correlation pattern 152, security manager 140 may determine that a high correlation exists between the first correlation pattern 148 and the second correlation pattern 152. For example, in the above example, the first correlation pattern 148 and the second correlation pattern 152 are more or less the same. This high correlation between the first correlation pattern 148 and the second correlation pattern 152 serves as a confirmation that the confidential information 120 was included in one or more communications 112 sent from the private user 108 to the public user 110.

In one or more embodiments, in response to determining that confidential information was included in one or more communications 112 sent from the private user 108 to the public user 110, security manager 140 may be configured to generate an alert and/or block subsequent communications 112 between the private user 108 and public user 110.

FIG. 2 illustrates a flowchart of an example method 200 for securing confidential information 120, in accordance with one or more embodiments of the present disclosure. Method 200 may be performed by the security manager 140 shown in FIG. 1.

At operation 202, security manager 140 monitors a plurality of written electronic communications (communications 112) from a first user (e.g., private user 108) and a second user (e.g., public user 110).

At operation 204, security manager 140 determines, based on the monitoring a text pattern 146 common across at least a portion of the plurality of written electronic communications 112.

As described above, security manager 140 may be configured to monitor electronic communications 112 between a private user 108 and a public user 110. The electronic communications 112 may include electronic written communications including, but not limited to, an electronic mail (email), a text message, and a written message sent on an internal chatting platform. It may be noted that the terms “electronic communication 112”, “electronic written communication 112” and “communication 112” are used interchangeably throughout this disclosure. Further, it may be noted that while embodiments of the present disclosure are described with reference to electronic written communications, a person having ordinary skill in the art may appreciate that the embodiments also apply to voice communications. Security manager 140 may be configured to monitor a plurality of electronic communications 112 from a private user 108 to the public user 110. Based on monitoring, the plurality of electronic communications 112, security manager 140 may be configured to determine a text pattern 146 that is common across at least a portion of the monitored electronic communications 112. For example, based on monitoring ten email communications that the private user 108 sent to the public user 110, security manager 140 may determine that a particular text pattern 146 is repeatedly used in six of the monitored email communications. Text pattern 146 may include, but is not limited to, repeated usage of one or more keywords, synonyms of the keywords, antonyms of the keywords or combinations thereof across the portion of the electronic communications 112; repeated usage of one or more phrases across the portion of the communications 112; repeated usage of a particular sentence structure across the portion of the written communications; and text from each of the portion of the written communications related to the same topic. One example text pattern 146 may include the sentence “let's get some ice cream” repeated across a threshold number of communications 112. Another example text pattern 146 may include the sentence “Red Sox are winning the baseball match” repeated across a threshold number of communications 112. In one embodiment, security manager 140 may be configured to designate a particular text pattern 146 as an identified text pattern 146 only when the text pattern 146 is found in at least a threshold number of monitored communications 112.

At operation 206, security manager 140 compares the determined text pattern 146 with the confidential information 120.

At operation 208, if a first correlation pattern 148 is not found between the text pattern 146 and the confidential information 120, method 200 ends here. On the other hand, if a first correlation pattern 148 is found between the text pattern 146 and the confidential information 120, method 200 proceeds to operation 210.

At operation 210, security manager 140 determines, based on the first correlation pattern 148, that the first user (e.g., private user 108) included at least a portion of the confidential information 120 in the written electronic communications 112 to the second user (e.g., public user 110).

As described above, once a particular text pattern 146 has been identified in communications 112 sent from the private user 108 to the public user 110, security manager 140 may be configured to determine a first correlation pattern 148 between the identified text pattern 146 and the confidential information 120 or portions thereof which the private user 108 has access to. As described above, security manager 140 may be configured to determine what confidential information 120 the private user 108 has access to by examining user permissions 144 associated with the private user 108. The first correlation pattern 148 indicates a pattern of correlation between the text pattern 146 and at least a portion of the confidential information 120. For example, the first correlation pattern 148 may include, but is not limited to, a correlation between one or more names in the confidential information 120 to an identified text pattern 146, a correlation between confidential information 120 related to performance data associated with an entity to the text pattern 146, a correlation between confidential information 120 related to a particular interaction associated with an entity to the text pattern; and a correlation between confidential information 120 related to internal operations of an entity to the text pattern. For example, an identified text pattern 146 may include the sentence “let's get some ice cream” repeated in several communication 112 from the private user 108 to the public user 110. By comparing, this identified text pattern to the confidential information 120 the private user 108 has access to, security manager 140 may determine a first correlation pattern 148 which may include the word “ice cream” correlated to a name of a particular entity, and the sentence “let's get some ice cream” correlated to “obtaining assets associated with the particular entity”. In another example, the identified text pattern may include the sentence “Red Sox are winning the baseball match”. In this example, the first correlation pattern 148 may include, the term “Red Sox” correlated to the name of a particular entity, “baseball match” correlated to performance of the particular entity, and the term “winning” correlated to improved performance of the particular entity.

In one or more embodiments, security manager 140 may be configured to identify the first correlation pattern 148 between an identified text pattern 146 and confidential information 120 by comparing a time at which a piece of confidential information 120 was made available to the private user 108 and a time at which the private user 108 sent a communication 112 to the public user 110. The idea here is that when the private user 108 repeatedly sends out a communication 112 to the public user 110 within a pre-set time period of a piece of confidential information 120 made available to the private user 108, there is a high likelihood that the private user 108 has included information associated with the piece of confidential information 120 in the communication 112. Security manager 140 may be configured to monitor when a piece of confidential information 120 is made available to the private user 108. For example, security manager 140 may record a time at which the private user 108 receives an email containing confidential performance related data associated with a particular entity. Security manager 140 may examine the performance related data received by the private user 108 and may determine that the performance related data indicates that the particular entity has had improved performance in the last 3 months. Upon detecting that the private user 108 sent a communication 112 to the public user 110 within a pre-set time period of receiving the performance related data, security manager 140 may be configured to compare a previously identified text pattern 146 with the performance related data and determine the first correlation pattern 146 between the text pattern 146 and the performance related data. In the example, when the identified text pattern 146 includes the sentence “Red Sox are winning the baseball match”, security manager 140 may determine the first correlation pattern 148 as including the term “Red Sox” correlated to the name of a particular entity, “baseball match” correlated to performance of the particular entity, and the term “winning” correlated to improved performance of the particular entity. In one embodiment, security manager 140 may be configured to designate a correlation pattern identified between the identified text pattern 146 and the piece of confidential information 120 as a valid and/or actionable first correlation pattern 148 only upon detecting the same correlation pattern in at least a threshold number of instances of the private user 108 receiving the piece of confidential information 120 and sending out a communication 112 to the public user 110 within the pre-set time period. In one embodiment, in response to determining the first correlation pattern 148, security manager 140 may be configured determine that the private user 108 included confidential information 120 in one or more communications 112 to the public user 110.

In one or more embodiments, security manager 140 may be configured to monitor one or more controlled interactions 150 performed by the public user 110. As described above, the term “controlled interactions 150” refers to certain interactions including and/or associated with obtaining or relinquishing assets associated with an organization/entity to which the confidential information 120 relates. Security manager 140 may be configured to determine a second correlation pattern 152 between controlled interactions 150 performed by the public user 110 and communications 112 received from the private user 108. For example, the second correlation pattern 152 may include a pattern of correlation between controlled interactions 150 performed by the public user 110 and an identified text pattern 146 in communications 112 received from the private user 108. In one embodiment, the second correlation pattern 152 may include a pattern of correlation between a particular type of controlled interactions 150 performed by the public user 110 and an identified text pattern 146 in communications 112 received from the private user 108. Security manager 140 may be configured to determine the second correlation pattern 152 based on comparing a time at which the public user 110 receives a communication 112 from the private user 108 and the time at which the public user 110 performs a controlled interaction 150. The idea here is that when the public user 110 repeatedly performs controlled interactions 150 within a pre-set time period of receiving communications 112 from the private user 108, there is a high likelihood that the public user 110 has received confidential information 120 in the communications 112 and is basing the controlled interactions 150 on the confidential information 120 received in the communications 112.

Upon detecting that the public user 110 performed a controlled interaction 150 within the pre-set time period of receiving a communication 112 from the private user 108, security manager 140 may be configured to compare a pre-identified text pattern 146 in the communication 112 with the controlled interaction 150 performed by the public user 110 and determine the second correlation pattern 152 based on the comparison. In the example, when the identified text pattern 146 in the communication 112 received by the public user 110 includes the sentence “Red Sox are winning the baseball match”, security manager 140 may detect a controlled interaction 150 performed by the public user 110 including obtaining one or more assets associated with a particular entity within the pre-set time period from receiving the communication 112. In this example, by comparing text pattern 146 and the controlled interaction 150, security manager 140 may determine the second correlation pattern as including the term “Red Sox” correlated to the name of the particular entity whose assets were obtained as part of the detected controlled interaction 150, “baseball match” correlated to performance of the particular entity, and the term “winning” correlated to improved performance of the particular entity. In one embodiment, security manager 140 may be configured to designate the correlation pattern identified between the identified text pattern 146 and a particular type of controlled interactions 150 (e.g., obtaining assets of the particular entity) as a valid and/or actionable first correlation pattern 148 only upon detecting the same correlation pattern in at least a threshold number of instances of the public user 110 receiving communications 112 from the private user 108 and the public user 110 performing the particular type of controlled interactions 150 with the pre-set time period of receiving the communications 112. In one embodiment, in response to determining the second correlation pattern 152, security manager 140 may be configured determine that the private user 108 included confidential information 120 in one or more communications 112 to the public user 110.

In one or more embodiments, security manager 140 may be configured to determine a third correlation pattern 154 between the first correlation pattern 148 and the second correlation pattern 152. In one embodiment, the determination of the third correlation pattern 154 may act as a confirmation that the private user 108 included a particular piece of confidential information 120 in communications 112 to the public user 110. The third correlation pattern 154 may include a correlation between the first correlation pattern 148 between the confidential information 120 and an identified text pattern 146, and the second correlation pattern between controlled interactions 150 performed by the public user 110 and the same identified text pattern 146 included in communications 112 received from the private user 108. Following the example described above wherein the identified text pattern 146 includes the sentence “Red Sox are winning the baseball match”, the first correlation pattern 148 may be determined as including the term “Red Sox” correlated to the name of a particular entity, “baseball match” correlated to performance of the particular entity, and the term “winning” correlated to improved performance of the particular entity. Additionally, the second correlation pattern 152 may also be determined as including the term “Red Sox” correlated to the name of the particular entity whose assets were obtained as part of the detected controlled interaction 150, “baseball match” correlated to performance of the particular entity, and the term “winning” correlated to improved performance of the particular entity. In this example, upon comparing the first correlation pattern 148 with the second correlation pattern 152, security manager 140 may determine that a high correlation exists between the first correlation pattern 148 and the second correlation pattern 152. For example, in the above example, the first correlation pattern 148 and the second correlation pattern 152 are more or less the same. This high correlation between the first correlation pattern 148 and the second correlation pattern 152 serves as a confirmation that the confidential information 120 was included in one or more communications 112 sent from the private user 108 to the public user 110.

At operation 212, security manager 140 generates an alert indicating that the first user (e.g., private user 108) included at least a portion of the confidential information 120 in the written electronic communications 112 to the second user (e.g., public user 110).

At operation 214, security manager 140 blocks subsequent written electronic communications 112 from the first user (private user 108) to the second user (e.g., public user 110).

As described above, in response to determining that confidential information was included in one or more communications 112 sent from the private user 108 to the public user 110, security manager 140 may be configured to generate an alert and/or block subsequent communications 112 between the private user 108 and public user 110.

In an example banking use case, the confidential information 120 may include revenue/profit data of an entity, pre-deal information, information related to legal/regulatory proceedings etc. The controlled interactions may include stock trades.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system comprising:
a memory that stores permissions associated with a first user and a second user, wherein the permissions indicate access to confidential information; and
a processor communicatively coupled to the memory and configured to:
monitor a plurality of written electronic communications from the first user to the second user, wherein:
the first user has access to the confidential information; and
the second user does not have access to the confidential information;
determine, based on the monitoring, a text pattern common across at least a portion of the plurality of written electronic communications;
compare the text pattern with the confidential information;
determine, based on the comparing, a first correlation pattern between the confidential information and the text pattern used in the written electronic communications;
determine, based on the first correlation pattern, that the first user included at least a portion of the confidential information in the written electronic communications to the second user;
generate an alert in response to determining that the first user included at least the portion of the confidential information in the written electronic communications to the second user; and
block subsequent written electronic communications from the first user to the second user.

2. The system of claim 1, wherein the text pattern comprises one or more of:
repeated usage of one or more keywords, synonyms of the keywords, antonyms of the keywords, or combinations thereof across the portion of the written electronic communications;
repeated usage of one or more phrases across the portion of the written electronic communications;
repeated usage of a particular sentence structure across the portion of the written communications; and
text from the portion of the written electronic communications related to a same topic.

3. The system of claim 1, wherein the first correlation pattern between the confidential information and the text pattern used in the written electronic communications comprises one or more of:
a correlation between one or more names in the confidential information to the text pattern;
a correlation between confidential information related to performance data associated with an entity to the text pattern;
a correlation between confidential information related to a particular interaction associated with an entity to the text pattern; and
a correlation between confidential information related to internal operations of an entity to the text pattern.

4. The system of claim 1, wherein the processor is configured to determine the first correlation pattern between the confidential information and the text pattern used in the written electronic communications by:
detecting at least a threshold number of instances of:
determining a time at which the confidential information was made available to the first user; and
determining that a written electronic communication was sent from the first user to the second user within a pre-set time period from the time the confidential information was made available to the first user; and
in response to detecting the threshold number of the instances, determining that the correlation pattern exists between the confidential information and the text pattern used in the written electronic communications.

5. The system of claim 1, wherein:
the first user is not authorized to perform a first set of interactions;
the second user is authorized to perform the first set of interactions; and
the processor is further configured to:
monitor the first set of interactions performed by the second user;
detect at least a threshold number of instances of:
determining that the second user performed an interaction from the first set of interactions within a pre-set time period of receiving a written electronic communication from the first user; and
determining, based on detecting the threshold number of the instances, that the interactions performed by the second user are based on confidential information included in the written electronic communications from the first user.

6. The system of claim 5, wherein the processor is further configured to:
determine a second correlation pattern between interactions performed by the second user and the text pattern, wherein the second correlation pattern correlates a type of the interactions performed by the second user to the text pattern; and
determine, based on the second correlation pattern, that the first user included at least a portion of the confidential information in the written electronic communications to the second user.

7. The system of claim 6, wherein the processor is further configured to:
determine a third correlation pattern between the first correlation pattern and the second correlation pattern; and
determine, based on the third correlation pattern, that the first user included at least a portion of the confidential information in the written electronic communications to the second user.

8. A method for securing confidential information comprising:
monitor a plurality of written electronic communications from a first user to a second user, wherein:
the first user has access to the confidential information; and
the second user does not have access to the confidential information;
determine, based on the monitoring, a text pattern common across at least a portion of the plurality of written electronic communications;
compare the text pattern with the confidential information;
determine, based on the comparing, a first correlation pattern between the confidential information and the text pattern used in the written electronic communications;
determine, based on the first correlation pattern, that the first user included at least a portion of the confidential information in the written electronic communications to the second user;
generate an alert in response to determining that the first user included at least the portion of the confidential information in the written electronic communications to the second user; and
block subsequent written electronic communications from the first user to the second user.

9. The method of claim 8, wherein the text pattern comprises one or more of:
repeated usage of one or more keywords, synonyms of the keywords, antonyms of the keywords, or combinations thereof across the portion of the written electronic communications;
repeated usage of one or more phrases across the portion of the written electronic communications;
repeated usage of a particular sentence structure across the portion of the written communications; and
text from the portion of the written electronic communications related to a same topic.

10. The method of claim 8, wherein the first correlation pattern between the confidential information and the text pattern used in the written electronic communications comprises one or more of:
a correlation between one or more names in the confidential information to the text pattern;
a correlation between confidential information related to performance data associated with an entity to the text pattern;
a correlation between confidential information related to a particular interaction associated with an entity to the text pattern; and
a correlation between confidential information related to internal operations of an entity to the text pattern.

11. The method of claim 8, wherein determining the first correlation pattern between the confidential information and the text pattern used in the written electronic communications comprises:
detecting at least a threshold number of instances of:
determining a time at which the confidential information was made available to the first user; and
determining that a written electronic communication was sent from the first user to the second user within a pre-set time period from the time the confidential information was made available to the first user;
in response to detecting the threshold number of the instances, determining that the correlation pattern exists between the confidential information and the text pattern used in the written electronic communications.

12. The method of claim 8, wherein:
the first user is not authorized to perform a first set of interactions; and
the second user is authorized to perform the first set of interactions;
further comprising:
monitoring the first set of interactions performed by the second user;
detecting at least a threshold number of instances of:
determining that the second user performed an interaction from the first set of interactions within a pre-set time period of receiving a written electronic communication from the first user; and
determining, based on detecting the threshold number of the instances, that the interactions performed by the second user are based on confidential information included in the written electronic communications from the first user.

13. The method of claim 12, further comprising:
determining a second correlation pattern between interactions performed by the second user and the text pattern, wherein the second correlation pattern correlates a type of the interactions performed by the second user to the text pattern; and
determining, based on the second correlation pattern, that the first user included at least a portion of the confidential information in the written electronic communications to the second user.

14. The method of claim 13, further comprising:
determining a third correlation pattern between the first correlation pattern and the second correlation pattern; and
determining, based on the third correlation pattern, that the first user included at least a portion of the confidential information in the written electronic communications to the second user.

15. A non-transitory computer-readable medium storing instructions that when executed by a processor cause the processor to:
monitor a plurality of written electronic communications from a first user to a second user, wherein:
the first user has access to confidential information; and
the second user does not have access to the confidential information;
determine, based on the monitoring, a text pattern common across at least a portion of the plurality of written electronic communications;
compare the text pattern with the confidential information;
determine, based on the comparing, a first correlation pattern between the confidential information and the text pattern used in the written electronic communications;
determine, based on the first correlation pattern, that the first user included at least a portion of the confidential information in the written electronic communications to the second user;
generate an alert in response to determining that the first user included at least the portion of the confidential information in the written electronic communications to the second user; and
block subsequent written electronic communications from the first user to the second user.

16. The non-transitory computer-readable medium of claim 15, wherein the text pattern comprises one or more of:
repeated usage of one or more keywords, synonyms of the keywords, antonyms of the keywords, or combinations thereof across the portion of the written electronic communications;
repeated usage of one or more phrases across the portion of the written electronic communications;
repeated usage of a particular sentence structure across the portion of the written communications; and
text from the portion of the written electronic communications related to a same topic.

17. The non-transitory computer-readable medium of claim 15, wherein the first correlation pattern between the confidential information and the text pattern used in the written electronic communications comprises one or more of:
a correlation between one or more names in the confidential information to the text pattern;
a correlation between confidential information related to performance data associated with an entity to the text pattern;
a correlation between confidential information related to a particular interaction associated with an entity to the text pattern; and
a correlation between confidential information related to internal operations of an entity to the text pattern.

18. The non-transitory computer-readable medium of claim 15, wherein determining the first correlation pattern between the confidential information and the text pattern used in the written electronic communications comprises:
detecting at least a threshold number of instances of:
determining a time at which the confidential information was made available to the first user; and
determining that a written electronic communication was sent from the first user to the second user within a pre-set time period from the time the confidential information was made available to the first user;
in response to detecting the threshold number of the instances, determining that the correlation pattern exists between the confidential information and the text pattern used in the written electronic communications.

19. The non-transitory computer-readable medium of claim 15, wherein:
the first user is not authorized to perform a first set of interactions; and
the second user is authorized to perform the first set of interactions;
wherein the instructions further cause the processor to:
monitor the first set of interactions performed by the second user;
detect at least a threshold number of instances of:
determining that the second user performed an interaction from the first set of interactions within a pre-set time period of receiving a written electronic communication from the first user; and
determining, based on detecting the threshold number of the instances, that the interactions performed by the second user are based on confidential information included in the written electronic communications from the first user.

20. The non-transitory computer-readable medium of claim 19, wherein the instructions further cause the processor to:
determine a second correlation pattern between interactions performed by the second user and the text pattern, wherein the second correlation pattern correlates a type of the interactions performed by the second user to the text pattern; and
determine, based on the second correlation pattern, that the first user included at least a portion of the confidential information in the written electronic communications to the second user.
